(19) United States
(12) Patent Application Publication
(10) Pub. No.: US 2012/0114824 A1
(43) Pub. Date: May 10, 2012

(54) Process for manufacturing a snack food product

(76) Inventors: Todd W. Gocha, Hopewell Junction, NY (US); Joseph Dileonardo, Elmhurst, IL (US)

(21) Appl. No.: 12/930,214

(22) Filed: Dec. 30, 2010

Related U.S. Application Data
(60) Provisional application No. 61/456,388, filed on Nov. 5, 2010.

(51) Int. Cl. A21D 13/00

(52) U.S. Cl. 426/560

(57) ABSTRACT

A process for producing a snack chip whereby a roll of dough is formed from pregelatinized flour and starch, the roll of dough is frozen, the frozen roll of dough is cut into thin slices, the slices are transported to a remote location, the slices are cooked at the remote location, and the cooked slices are served to restaurant patrons.

This application claims priority based on provisional patent application Ser. No. 61/456,388, filed Nov. 5, 2010.

This invention relates to food products and methods for producing the same.

More particularly, the invention relates to a method to produce a snack chip.

Those skilled in the art have for many years pursued the development of new and improved processes to produce food products. Accordingly, an improved process to produce snack chips or other food products is desirable.

Therefore, it is a principal object of the invention to provide an improved process to produce a food product.

This, and other and further objects and advantages of the invention are apparent from the following detailed description thereof.

We have discovered a new food manufacturing system which can be carried out on a reduced scale or which can be carried out in a commercialized scaled-up continuous manufacturing process.

### The Frozen Log Embodiment

In one presently preferred embodiment of the invention, a snack chip is produced. A snack dough composition is prepared at room temperature by admixing a solid composition and a liquid composition. A pregelatinized starch and a pregelatinized flour collectively comprise at least 40% by weight of the solid composition. The dough composition is formed into an elongate log. The elongate log is frozen. The frozen elongate log is cut into thin slices each having a thickness in the range of 0.025 to 0.125 inch. The cut slices are dried. The dried slices are packaged. The packaged slices are transported to a selected restaurant destination, and are fried for one to ten seconds in vegetable oil at a temperature in the range of 300 degrees to 370 degrees F. The fried slices are served to patrons of said restaurant. The thickness of a slice is the smallest dimension of the slice. For example, if a log is cylindrically shaped and has a two inch diameter, then a slice has a two inch diameter and a thickness in the range of 0.025 to 0.125 inch. The thickness dimension is perpendicular to the diameter dimension.

Although the dough composition can be prepared at any desired temperature, a particular advantage of the frozen log embodiment of the invention is that the dough mixture need not be heated, which conserves energy.

Preparation of a dough log, freezing the dough log, cutting slices from the frozen log, drying the slices, and packaging the dried slices is preferably performed as a continuous, assembly line—like process, although this need not be the case. Freezing the logs is critical because it, along with the pregeletanized flour and starch, enables the logs to be cut into thin slices.

Before a slice is dried, the moisture content may, by way of example, be in the range of 25% to 80% by weight, preferably 35% to 60%. The amount of water removed from a slice during drying can vary as desired, however, moisture is typically removed in an amount sufficient to increase the rigidity of the slices, to minimize the likelihood that the slices will stick together when packaged, to facilitate the expansion and puffing of the slices when they are cooked, and to minimize the amount of time required to cook the slices by frying the slices in heated vegetable oil, by baking the slices, by microwaving the slices, etc. The dried slices preferably have 6% to 15% moisture by weight, more preferably 8% to 12% moisture by weight. Unusually light crispy chips are produced, which can have a “melt in the mouth” texture.

In another embodiment of the invention, after the slices are dried, they are, at a selected time, fried or otherwise cooked at the production facility, and are packaged to produce a finished product. The packaged slices, are transported to a retail outlet and sold to the public.

Still another embodiment of the invention packages the frozen logs, and ships the logs to a restaurant or other associated facility. The restaurant cuts slices from the logs, dries the slices, cooks the slices, and sells at retail the slices to consumers.

Any desired liquid(s) can be utilized in the production of the dough used to form logs. Such liquids can, by way of example and not limitation, include water, fruit juice, vegetable juice, citrus juice, chicken broth, beef broth, soup, milk, sauces, gravies, or tomato juice.

When the dough composition is prepared, inclusions in the form of solid pieces or particles can be included. Inclusions can comprise any solid food composition such as, for example, comprise nuts, candy, dried fruit, cheese, grains, puffed rice, puffed wheat, pop corn, etc.

The total weight of solids utilized in preparing the snack dough is comprised of more than 40% by weight, more preferably more than 60% by weight, and most preferably more than 80% by weight. The solids can include pregelatinized flour, pregelatinized starch, inclusions, spices, berries, flavoring, or other solid food compositions. While the presently preferred embodiment of the invention includes both pregelatinized flour and pregelatinized starch, another preferred embodiment of the invention utilizes pregelatinized starch and little or no pregelatinized flour. The total weight of solids utilized in preparing a batch of the snack dough can include 1% to 75%, preferably 5% to 60%, by weight of cheese, berries, or other inclusions. The total weight of solids utilized in preparing a batch of the snack dough can also be comprised of 0.001% to 20% by weight of salt, cinnamon, sugar, onion powder, chili powder, flavoring, or other solid condiments (i.e., seasonings). Liquid or semi-liquid condiments such as vanilla can also be included in a batch of the snack dough in an amount that equals 0.001% to 20% of the total weight of solids that are used to prepare the snack dough. For example, if the total weight of solids used to prepare the snack dough is 200 grams, and the liquid condiments are 5% of the total weight of solids, then the amount of liquid condiments (such as vanilla) equals 5% of 200 grams or 10 grams.

As used herein, an inclusion is a composition that is not generally uniformly distributed throughout the dough log that is produced by admixing the various components comprising the dough log. Inclusions typically retain their structural integrity and exist at separate discrete locations throughout a dough log. For example, flour and starch are not inclusions because they are generally uniformly distributed throughout the dough log. Solid condiments like fine grained salt and sugar typically are not inclusions because they are generally uniformly distributed throughout the final dough log, and further typically are dissolved by the water in the log. Liquid condiments like vanilla are not inclusions because they are generally uniformly distributed through the final dough log. Water is not an inclusion because it is generally uniformly distributed throughout the dough log. Pieces of cheese, onion, and rock candy greater than one-sixteenth to one-eighth of an inch in size often comprise inclusions because they are not broken up or do not dissolve during production of the dough log and remain in the dough log as discreet particles. Whole blue berries and cherries often comprise inclusions because they are not broken up during production of the dough log and remain in the dough as discreet berries. If a soup is utilized in producing a dough log, the soup may or may not include inclusions. A puree soup like tomato soup often does not contain any solid particles of significant size and basically comprises a liquid. On the other hand, a vegetable soup typically consists of a liquid and a variety of vegetables which could exist as inclusions in a dough log. For example, the peas and corns in vegetable soup might well retain their integrity and exist as inclusions a dough log. On the other hand, the noodles in vegetable soup might disintegrate, be uniformly distributed throughout a dough log, and not comprise inclusions. The liquid component, or broth, of a vegetable soup would be uniformly distributed throughout the log and would not comprise an inclusion. The chocolate chips commonly found in chocolate chip cookies are an example of inclusions.

In one preferred embodiment of the invention, the inclusions comprise small pieces of hard candy, rock sugar, dried fruit, or other substantially solid food compositions that include a natural or artificial sweetener, and, the amount of sugar or other sweetener that is dispersed throughout the dough is minimized. The use of such substantially solid food compositions helps to minimize excessive softening of the dough which can occur when sugar or other sweeteners are generally uniformly dispersed throughout the dough. If the dough is excessively soft, it is difficult to produce the crisp fried chip desired in the practice of the invention. After the dough log is prepared, and before it is sliced, the inclusions have a size in the range of one-sixteenth inch to one-half inch, preferably in the range of one-sixteenth inch to one quarter inch.

The quantity of water or other liquids in a batch of the snack dough is in the range of 10% to 80% of the weight of the dough that is produced. The quantity of solids in a batch of the snack dough is, as noted, in the range of 40% to 80% of the weight of the dough that is produced. If desired, thickeners such as carrageenan, guar gum, and gelatin can be included in the final dough in minor effective amounts. Further, if desired, fillers and/or binders such as dextrin or egg whites can also be included in the final dough in minor effective amounts.

When the liquid(s) and solids (including, if desired, inclusions and condiments) are admixed to produce the snack dough, a paddle or other mixing utensil is utilized which rotates at a relatively slow rate of speed, typically ten to thirty rpm, although this can be adjusted as desired. Examples of other mixing utensils include vertical mixers and horizontal mixers in which various different blade configurations are utilized. A slow rpm minimizes damage to inclusions which may comprise a portion of the dough. In an alternate embodiment of the invention, starches and water are mixed at high speed, after which inclusions are admixed into the starch-water mixture at a slow speed which minimizes damage to the inclusions. Any desired mixing equipment can be utilized. Some extruding equipment is designed to accomplish mixing. Another method of producing a snack dough is a pasta production system, a pretzel production system, or a bread production system. Another example of extruding equipment is a cooker extruder.

After the snack dough is prepared, it is formed into logs. This can be carried out manually or by any desired mechanical equipment; however, extrusion is presently preferred because it lends itself to incorporation in a continuous production line. The rate of extrusion is, if possible, minimized to minimize the magnitude of shear forces which may damage inclusions or other components in the snack dough. While the extrusion rate can vary as desired, one preferred rate of extrusion of a log is ten to thirty feet per minute. Individual logs can be extruded one by one, or, a continuous log can be extruded and cut at selected intervals to produce logs of a desired length(s). The diameter, or width, of the log can vary as desired, but is presently preferably in the range of one to six inches. The shape and dimension of the log can also vary as desired, with the standard cylindrical shape currently being preferred.

After a log is produced, it is frozen at a temperature less than thirty-two degrees F. In comparison to processes that require that a log be dried, freezing has the advantage of significantly shortening the time required to produce a snack dough log. Further, the rate at which a log is frozen can be varied as desired. Some commercial equipment permits a log to be frozen in a relatively short period of time. By way of example, it presently typically takes 20 to 45 minutes to freeze a two to four inch diameter log.

After a log is frozen, it is cut into thin dough slices. Each dough slice has a thickness in the range of 0.025 inch to 0.125 inch, preferably in the range of 0.025 to 0.090 inch, more preferably in the range of 0.025 to 0.070 inch. A log can be sliced manually with a knife, or using a mechanical apparatus. Thin dough slices are important in the practice of the invention and facilitate the rapid cooking of the slices. When a slice is fried in a vegetable oil bath, the temperature of the bath is in the range of 250 to 450 degrees F., preferably 275 to 425 degrees F., more preferably in the range of 300 degrees F. to 400 degrees F., and most preferably in the range of 300 degrees F. to 370 degrees F. The ability to utilize a low cooking temperature of 330 degrees F. or less is an advantage because it minimizes the formation of undesirable food byproducts while a slice is being cooked. As earlier noted, other methods of cooking the dough slices can be utilized. For example, the slices can be fried in a heated lard or tallow bath.

Still another advantage of the frozen log embodiment of the invention is that the time required to cook a slice is relatively short, typically in the range of two to five seconds. A short cooking time also minimizes the formation of undesirable food byproducts, such as carcinogens. The cooking time for a dough slice is preferably in the range of one to ten seconds, more preferably one to six seconds.

### The Dried Log Embodiment of the Invention

In an alternate embodiment of the invention, ordinary ungelatinized flour and starch are utilized instead of pregelatinized flour and starch. This ordinarily requires that the flour and/or starch be heated as part of the process to produce snack dough that is formed into a log.

Solids and water (or another preferred liquid(s)) are, as is the case in the frozen log embodiment of the invention, utilized to prepare the snack dough. An ungelatinized starch and an ungelatinized flour collectively comprise at least 40% by weight of the solid composition. The dough composition is formed into an elongate log. The log is dried. The dried log is cut into thin slices each having a thickness in the range of 0.025 to 0.125 inch. The cut slices are dried. The dried slices are packaged. The packaged slices are transported to a selected restaurant destination, and are fried for one to ten seconds in vegetable oil at a temperature in the range of 300 degrees to 370 degrees F. The fried slices are served to patrons of said restaurant.

Preparation of a dough log, drying the log, cutting slices from the dried log, drying the slices, and packaging the dried slices is preferably performed as a continuous, assembly line-like process, although this need not be the case.

Before a log is dried, the moisture content may, by way of example, be in the range of 25% to 80% by weight, preferably 35% to 60% by weight. The amount of water removed from a slice during drying can vary as desired, however, moisture is typically removed in an amount sufficient to increase the rigidity of the log sufficiently to facilitate cutting slices from the log, i.e., such that the dough is not sticky and adheres to a cutting blade. Sufficiently drying a log can be difficult because the outer surface of the log tends to dry more quickly than the interior of the log and can become somewhat hard and brittle; this hardening can also prevent a slice from properly puffing during frying. The formation of a hard, brittle outer surface can be avoided or minimized by slowly drying the log to permit moisture from the interior of the log to move outwardly toward the outer surface of the log. Slices cut from the log are further dried to minimize the likelihood that the slices will stick together when packaged, and to minimize the amount of time required to cook the slices by frying the slices in heated vegetable oil, by baking the slices, by microwaving the slices, etc. The dried slices preferably have 6% to 15% moisture by weight, more preferably 8% to 12% moisture by weight. Unusually light crispy chips are produced.

In another embodiment of the invention, after the slices are dried, they are immediately fried or otherwise cooked at the production facility, and are packaged. The packaged slices, are transported to a retail outlet and sold to the public.

Still another embodiment of the invention packages the dried logs, and ships the logs to a restaurant or other associated facility. The restaurant cuts slices from the logs, dries the slices, cooks the slices, and sells at retail the slices to consumers.

Any desired liquid(s) can be utilized in the production of the dough used to form logs. Such liquids can, by way of example and not limitation, include water, fruit juice, vegetable juice, citrus juice, chicken broth, beef broth, soup, milk, or tomato juice.

When the dough composition is prepared, inclusions in the form of solid pieces or particles can be includes. Inclusions can comprise any solid food composition such as, for example, comprise nuts, candy, dried fruit, cheese, etc.

The total weight of solids utilized in preparing a batch of the snack dough is comprised of more than 40% by weight, more preferably more than 60% by weight, and most preferably more than 80% by weight. The solids can include ungelatinized flour, ungelatinized starch, inclusions, spices, berries, flavoring, or other solid food compositions. While the presently preferred embodiment of the invention includes both ungelatinized flour and ungelatinized starch, another preferred embodiment of the invention utilizes ungelatinized starch and little or no ungelatinized flour. The total weight of solids utilized in preparing a batch of the snack dough can include 1% to 75%, preferably 5% to 60%, by weight of cheese, berries, or other inclusions. The total weight of solids utilized in preparing a batch of the snack dough can also be comprised of 0.001% to 20% by weight of salt, cinnamon, sugar, onion powder, chili powder, flavoring, or other solid condiments. Liquid or sem-liquid condiments can also be included in a batch of the snack dough in an amount that equals 0.001% to 20% of the total weight of solids that are used to prepare the snack dough. For example, if the total weight of solids used to prepare a batch of the snack dough is 200 grams, and the liquid condiments are 5% of the total weight of solids, then the amount of liquid condiments (such as vanilla) equals 5% of 200 grams or 10 grams.

The quantity of water or other liquids in a batch of the snack dough is in the range of 20% to 80% of the weight of the dough that is produced. The quantity of solids in a batch of the snack dough is, as noted, in the range of 40% to 80% of the weight of the dough that is produced. If desired, thickeners such as carrageenan, guar gum, and gelatin can be included in the final dough in minor effective amounts. Further, if desired, fillers and/or binders such as dextrin, eggs, or egg whites can also be included in the final dough in minor effective amounts.

When the liquid(s) and solids (including, if desired, inclusions and condiments) are admixed to produce a batch of the snack dough, a paddle or other mixing utensil is utilized which rotates at a relatively slow rate of speed, typically ten to thirty rpm, although this can be adjusted as desired. A slow rpm minimizes damage to inclusions which may comprise a portion of the dough. In an alternate embodiment of the invention, starches and water are mixed at high speed, after which inclusions are admixed into the starch-water mixture at a slow speed which minimizes damage to the inclusions. Any desired mixing equipment can be utilized. Some extruding equipment is designed to accomplish mixing.

After the snack dough is prepared, it is formed into logs. This can be carried out manually or by any desired mechanical equipment; however, extrusion is presently preferred because it lends itself to incorporation in a continuous production line. The rate of extrusion is, if possible and preferred, minimized to minimize the magnitude of shear forces which may damage inclusions or other components in the snack dough. While the extrusion rate can vary as desired, one preferred rate of extrusion of a log is ten to thirty feet per minute. Individual logs can be extruded one by one, or, a continuous log can be extruded and cut at selected intervals to produces logs of a desired length(s). The diameter, or width, of the log can vary as desired, but is presently preferably in the range of one to six inches. The shape and dimension of the log can also vary as desired, with the standard cylindrical shape currently being preferred. Examples of other log shapes are rectangular, square, and triangular shapes.

After a log is produced, it is dried, either at ambient temperature or in an oven at an elevated temperature.

After a log is dried, it is cut into thin dough slices. Each dough slice has a thickness in the range of 0.025 inch to 0.125 inch, preferably in the range of 0.025 to 0.090 inch, more preferably in the range of 0.025 to 0.070 inch. A log can be sliced manually with a knife, or using a mechanical apparatus. Thin, dried dough slices are important in the practice of the invention and facilitate the rapid cooking of the slices. When a slice is fried in a vegetable oil bath, the temperature of the bath is in the range of 250 to 450 degrees F., preferably 275 to 425 degrees F., more preferably in the range of 300 degrees F. to 400 degrees F., and most preferably in the range of 300 degrees F. to 370 degrees F. The ability to utilize a low cooking temperature of 330 degrees F. or less is an advantage because it minimizes the formation of undesirable food byproducts while a slice is being cooked.

Still another advantage of the dried log embodiment of the invention is that the time required to cook a slice is relatively short, typically in the range of two to five seconds. A short cooking time also minimizes the formation of undesirable food byproducts. The cooking time for a dough slice is preferably in the range of one to ten seconds, more preferably one to six seconds.

The following examples are presented by way of illustration, and not limitation, of the invention.

### EXAMPLE 1

The following ingredients are, to form a snack dough, combined and blended for three minutes at room temperature in a mixer using a paddle turning at fifteen rpm. A slow turning speed is utilized to minimize the generation of shear forces.

| Ingredient | Grams |
|---|---|
| Pregelatinized potato starch | 120 |
| Pregelatinized corn flour | 160 |
| Salt | 8 |
| Shredded Cheddar cheese | 40 |
| Water | 380 |

The dough is removed from the mixer and is gently manually rolled into a cylindrically shaped log having a diameter of about two inches. The log is frozen at a temperature of twenty-five degrees F. The log is, while frozen, cut into thin circular slices each having a thickness of 0.055 inch. To produce the slices, a cutting blade is indexed along the length of the log and is used to repeatedly cut through the log in a direction of travel perpendicular to the longitudinal axis of the log. The circular slices are dried to a moisture content of 10% by weight. The dried slices are packaged and transported to a remote selected restaurant. At the restaurant, the slices are fried for three seconds in a vegetable oil bath. The bath has a temperature of 330 degrees F. The slices puff while in the bath such that the thickness of the each slice increases and is greater than 0.055 inch.

### EXAMPLE 2

The following ingredients are, to form a snack dough, combined and blended for three minutes at room temperature in a mixer using a paddle turning at fifteen rpm. A slow turning speed is utilized to minimize the generation of shear forces.

| Ingredient | Grams |
|---|---|
| Pregelatinized tapioca starch | 125 |
| Pregelatinized corn flour | 155 |
| Salt | 8 |
| Dehydrated onion pieces | 30 |
| Water | 390 |

The dough is removed from the mixer and is extruded into a hexagonally shaped log having a diameter of about three inches. The log is frozen at a temperature of twenty-five degrees F. The log is, while frozen, cut into thin circular slices each having a thickness of 0.050 inch. To produce the slices, a cutting blade is indexed along the length of the log and is used to repeatedly cut through the log in a direction of travel perpendicular to the longitudinal axis of the log. The circular slices are dried to a moisture content of 8% by weight. The dried slices are packaged and transported to a remote selected restaurant. At the restaurant, the slices are fried for three seconds in a vegetable oil bath. The bath has a temperature of 310 degrees F. The slices puff while in the bath such that the thickness of the each slice increases and is greater than 0.050 inch.

### EXAMPLE 3

Example 1 is repeated except that after the dough is formed, it is, instead of being manually rolled, extruded to produce the log. The log is extruded at a rate of fifteen feet per minute. The length of a dough log produced in accordance with any of the embodiments of the invention can vary, but is typically in the range of six to twelve inches.

### EXAMPLE 4

Example 1 is repeated except that after the dough is made, it is, instead of being manually rolled, mechanically rolled by a machine to produce the cylindrical shaped log(s).

### EXAMPLE 5

Example 1 is repeated except that after the log is formed, it is not frozen but is instead dried in an oven at 330 degrees F. for four hours. The dried log is cooled, and wrapped in a polymer film. The wrapped log is shipped to a restaurant destination, and is cut into slices. The slices are dried, fried, and sold or served to patrons.

### EXAMPLE 6

Example 1 is repeated except that after the log is formed, it is not frozen but is instead dried by refrigerating the log for twelve hours, after which the log is wrapped in a flexible polymer sheet, refrigerated, and shipped to the restaurant. The log is cut into thin slices, the slices are dried, and the slices are fried and sold to patrons at the restaurant.

### EXAMPLE 7

The following ingredients are, to form a snack dough, combined and blended for one minutes at room temperature in a mixer using a paddle turning at twenty rpm. A slow turning speed is utilized to minimize the generation of shear forces.

| Ingredient | Grams |
|---|---|
| Standard ungelatinized potato flakes | 120 |
| Potato starch, standard, unmodified, | 160 |
| ungelatinized | |
| Salt | 8 |

350 grams of water is added to the resulting mixture and mixing is continued for an additional minute. The log is dried either by refrigeration (Example 6) or in an oven (Example 5). After drying, the log is cut into slices. The slices are dried to a moisture content of 12% by weight. The slices are packaged in a sealed bag and shipped to a restaurant. The circular slices each have a thickness of about 0.045 inch. At the restaurant, the slices are fried for five seconds in a vegetable oil bath. The bath has a temperature of 340 degrees F. The slices puff while in the bath such that the thickness of the slice increases and is greater than 0.055 inch.

In one embodiment of the invention an alternate cutting procedure is utilized to produce slices. A frozen log is initially cut lengthwise into elongate generally orthogonal thin slices in the same fashion that the log from a tree is cut lengthwise into long planks. Each dough slice has a thickness in the range of 0.025 inch to 0.125 inch, preferably in the range of 0.025 to 0.090 inch, more preferably in the range of 0.025 to 0.070 inch. The slices are dried, stacked in registration with one another, and are cut in a direction that is perpendicular to the longitudinal axes of the slices to produce thin, rectangularly-shaped, square-shaped, or ovular-shaped slices, i.e., each slice is cut in a manner similar to that when a cookie cutter is used to cut cookies out of a flat, thin sheet of dough. The die used to cut the stacked, dried slices can cut the slice in a checkerboard fashion so that one pass or “cut” of the die through the stacked slices is sufficient to completely cut up simultaneously each of the stacked slices. In another embodiment of the invention, each slice is cut up separately from the other slices.

In another embodiment of the invention an alternate cutting procedure is utilized to produce slices. Instead of a frozen log, a frozen sheet of snack dough is prepared, much like a sheet of dough is prepared when Christmas cookies are being made. The thickness of the sheet can vary as desired, but the sheet preferably is thick enough to permit the sheet to be cut lengthwise into elongate generally orthogonal thin slices in the same fashion that the log from a tree is cut lengthwise into long orthogonal planks. Each dough slice has a thickness in the range of 0.025 inch to 0.125 inch, preferably in the range of 0.025 to 0.090 inch, more preferably in the range of 0.025 to 0.070 inch. The frozen sheet typically will have a thickness of at least one inch. The slices are dried, stacked in registration with one another, and are cut in a direction that is perpendicular to the longitudinal axes of the slices to produce thin, rectangularly-shaped, square-shaped, or ovular-shaped slices, i.e., each slice is cut in a manner similar to that when a cookie cutter is used to cut cookies out of a flat, thin sheet of dough. The die used to cut the stacked, dried slices can cut the slice in a checkerboard fashion so that one pass or “cut” of the die through the stacked slices is sufficient to completely cut up simultaneously each of the stacked slices. In another embodiment of the invention, each slice is cut up separately from the other slices.

Having described our invention in such terms as to enable those skilled in the art to understand and practice it, and having described the preferred embodiments and best mode thereof,

We claim:

1. A process to produce a snack chip comprising the steps of
(a) preparing at room temperature a dough composition by admixing a solid composition and a liquid composition, a pregelatinized starch and a pregelatinized flour collectively comprising at least 40% by weight of the solid composition;
(b) forming said dough composition into an elongate log;
(c) freezing said elongate log;
(d) cutting said frozen elongate log into thin slices each having a thickness in the range of 0.025 to 0.125 inch;
(e) drying said slices;
(f) packaging said dried slices;
(g) transporting said packaged, dried slices to a selected restaurant destination;
(h) frying said slices for one to ten second in vegetable oil at a temperature in the range of 300 degrees to 370 degrees F.; and,
(i) serving said fried slices to patrons of said restaurant.
